(19) United States
(12) Patent Application Publication
(10) Pub. No.: US 2025/0158203 A1
(43) Pub. Date: May 15, 2025

(54) CELL MODULE BRACKET AND CELL MODULE

(71) Applicant: ZHEJIANG UNIVERSITY OF SCIENCE & TECHNOLOGY, Hangzhou City (CN)

(72) Inventors: Youming TANG, Hangzhou City (CN); Songfeng ZHONG, Hangzhou City (CN); Yi ZHANG, Hangzhou City (CN); Ping WANG, Hangzhou City (CN)

(73) Assignee: ZHEJIANG UNIVERSITY OF SCIENCE & TECHNOLOGY, Hangzhou City (CN)

(21) Appl. No.: 18/673,199

(22) Filed: May 23, 2024

(30) Foreign Application Priority Data
Nov. 15, 2023 (CN) 202311521403.6

(51) Int. Cl. H01M 50/262; H01M 50/213; H01M 50/271

(52) U.S. Cl. CPC H01M 50/262; H01M 50/213; H01M 50/271

(57) ABSTRACT

A cell module bracket is provided. The cell module bracket includes a base and a top cover. The base and the top cover are connected to each other through a lifting assembly, and the lifting assembly is configured for adjusting the height of the top cover. Each of the base and the top cover is formed with multiple fixing grooves, and the multiple fixing grooves of the base are in one-to-one correspondence to the multiple fixing grooves of the top cover. Each of the fixing grooves is provided with a clamping assembly disposed therein. The clamping assembly includes multiple clamping parts uniformly distributed around a cell. A clamping space for fixing the cell is formed among the clamping parts, and each of the clamping parts is connected with an adjusting assembly. A cell module is provided. The cell module includes the cell module bracket.

### CROSS-REFERENCE TO RELATED APPLICATION

This patent application claims the benefit and priority of Chinese Patent Application No. 202311521403.6 filed with the China National Intellectual Property Administration on Nov. 15, 2023, the disclosure of which is incorporated by reference herein in its entirety as part of the present application.

### TECHNICAL FIELD

The present disclosure relates to the technical field of new energy batteries, in particular to a cell module bracket and a cell module.

### BACKGROUND

At present, the cell module usually includes a cell module bracket, and multiple cylindrical cells can be fixed in the battery module bracket. The cell module bracket includes a base and a top cover. The base and the top cover are connected through upright posts, and multiple fixing grooves are formed in the base for fixing the cylindrical cells.

However, the size of the fixing groove in the existing cell module bracket is not adjustable, and the height of the upright post is also not adjustable, so it is impossible to be applicable to cells with different sizes, and it is necessary to make corresponding modules according to different cells for matching. So, the cost is high, and the efficiency is low.

Therefore, there is an urgent need to provide a novel cell module bracket to solve the problems existing in the prior art.

### SUMMARY

The purpose of the present disclosure is to provide a cell module bracket and a cell module so as to solve the problems in the prior art. Cells with different sizes can be fixed, so that the practicability is improved.

In order to achieve the purpose, the present disclosure provides the following scheme.

The present disclosure provides a cell module bracket. The cell module bracket includes a base and a top cover, where the base and the top cover are connected to each other through lifting assemblies, and the lifting assemblies are configured for adjusting the height of the top cover; each of the base and the top cover is formed with multiple fixing grooves, and the multiple fixing grooves of the base are in one-to-one correspondence to the multiple fixing grooves of the top cover; where each of the fixing grooves is provided with a clamping assembly disposed therein, the clamping assembly includes multiple clamping parts, which are configured to be uniformly distributed around a cell, a clamping space for fixing the cell is formed among the multiple clamping parts, each of the clamping parts is connected with an adjusting assembly, and the adjusting assembly is able to drive a corresponding one of the clamping parts to move so as to adjust a size of the clamping space.

Preferably, the fixing grooves of the top cover are uniformly distributed in the top cover in an array mode, the fixing grooves of the base are uniformly distributed in the base in an array mode, where each of the fixing grooves of the top cover, and the fixing grooves of the base is formed and enclosed by an annular plate, and a bottom of each of the fixing grooves of the base is provided with a supporting plate.

Preferably, the clamping parts are clamping plates, and one side adjacent to the cell of each of the clamping plates, is provided with an abutting surface that is abutted with the cell.

Preferably, the abutting surface of each of the clamping plates is covered with a rubber layer, and a surface of the rubber layer is coated with an insulating rubber layer.

Preferably, the clamping plates include two clamping plates, and the two clamping plates are oppositely arranged on both sides of the cell;

or, the clamping plates include four clamping plates, and the four clamping plates are uniformly distributed along a circumferential direction of the cell.

Preferably, the adjusting assembly includes a bolt and an adjusting nut. One end of the bolt is connected with one side, away from the cell, of the corresponding clamping part. Another end of the bolt penetrates through the annular plate and is mounted with the adjusting nut, and the clamping part can be driven to move by rotating the adjusting nut.

Preferably, each of the lifting assemblies includes a lower upright post and an upper upright post, which are vertically arranged on the base and the top cover, respectively. The upper upright post is slidably connected to the lower upright post, and the upper upright post and the lower upright post can be locked to each other through a locking mechanism.

Preferably, a central hole is axially formed in the lower upright post, and the bottom of the upper upright post is slidably arranged in the central hole; the locking mechanism includes a limiting pin and multiple limiting holes, the limiting pin is arranged in a radial direction on a side wall of the upper upright post, a return spring is arranged between the limiting pin and the upper upright post, the limiting holes are arranged in the lower upright post along an axis of the lower upright post, and the limiting holes radially penetrate through a side wall of the lower upright post, so that the height of the top cover can be adjusted by snapping the limiting pin in the limiting holes at different positions.

Preferably, the base and the top cover are both of rectangular structures, and the lifting assemblies are arranged between four corners of the base and four corners of the top cover.

The present disclosure also provides a cell module. The cell module includes the cell module bracket.

Compared with the prior art, some embodiments have the following technical effects.

In the present disclosure, the height of the top cover can be adjusted through the lifting assemblies between the base and the top cover to be applicable to the cells with different heights. The clamping assembly is arranged in the fixing groove, includes a clamping part and an adjusting assembly. The clamping part can be driven to move through the corresponding adjusting assembly so as to adjust the size of the clamping space to be applicable to cells with different sizes. The cell module bracket can be applicable to cells of different sizes and heights so that practicability is improved.

### BRIEF DESCRIPTION OF THE DRAWINGS

In order to illustrate the embodiments of the present disclosure or the technical solutions in the prior art more clearly, the drawings needed in the embodiments will be briefly introduced hereinafter. Apparently, the drawings in the following description are only some embodiments of the present disclosure. For those skilled in the art, other drawings can be obtained according to these drawings without paying creative labor.

FIG. 1 is a split schematic diagram of a base and a top cover of a first cell module bracket in the embodiment of the present disclosure.

FIG. 2 is a structural schematic diagram of the base of a first cell module bracket in the embodiment of the present disclosure.

FIG. 3 is a three-dimensional diagram of a first cell module bracket in the embodiment of the present disclosure.

FIG. 4 is a split schematic diagram of a base and a top cover of a second cell module bracket in the embodiment of the present disclosure.

FIG. 5 is a structural schematic diagram of the base of a second cell module bracket in the embodiment of the present disclosure.

FIG. 6 is an enlarged view of a clamping assembly of a second cell module bracket in the embodiment of the present disclosure.

FIG. 7 is a three-dimensional diagram of a second cell module bracket in the embodiment of the present disclosure.

Reference labels: the base 1; fixing grooves 2; clamping plates 3; lower upright posts 4; limiting holes 5; limiting pins 6; upper upright posts 7; the top cover 8; bolts 9; adjusting nuts 10; and supporting plates 11.

### DETAILED DESCRIPTION OF THE EMBODIMENTS

The technical solutions in the embodiments of the present disclosure will be described clearly and completely hereinafter with reference to the drawings of the embodiments of the present disclosure. The described embodiments are some, but not all, of the embodiments of the present invention. Based on the described embodiments of the present disclosure, all other embodiments obtained by those skilled in the art without paying creative labor fall in the scope of protection of the present invention.

The purpose of the embodiments is to provide a cell module bracket and a cell module to solve the problems in the prior art. The embodiments can accommodate cells of different sizes, improving practicability.

In order to make the above objects, features, and advantages of the present disclosure more obvious and understandable, the present disclosure will be further explained in detail hereinafter with reference to the drawings and specific embodiments.

### Embodiment I

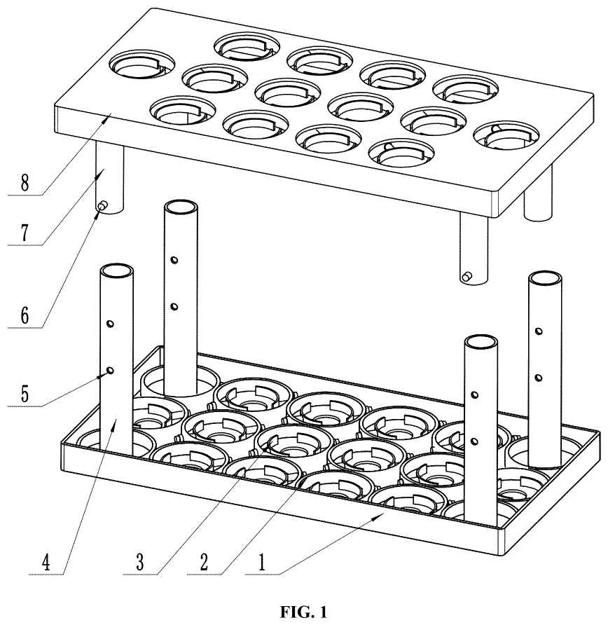

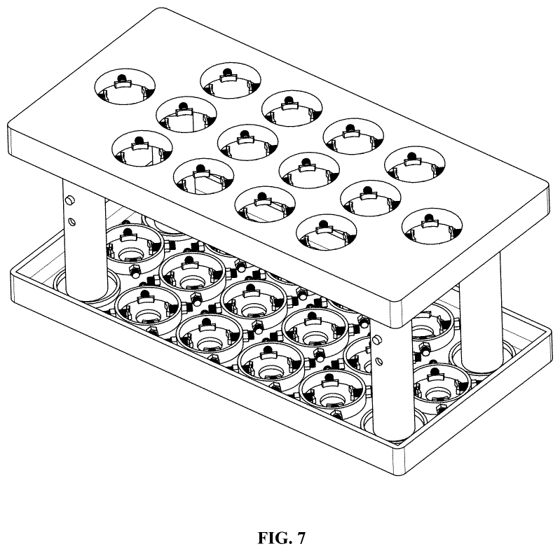

As shown in FIG. 1 to FIG. 7, a cell module bracket is provided in the embodiment. The cell module bracket mainly includes a base 1 and a top cover 8. The base 1 and the top cover 8 are connected to each other through lifting assemblies. The lifting assemblies are configured to adjust the height of the top cover 8 so as to fix cells of different heights. Each of the base 1 and the top cover 8 is formed with multiple fixing grooves 2, and the multiple fixing grooves 2 of the base 1 are in one-to-one correspondence to the multiple fixing grooves 2 of the top cover 8. The fixing grooves 2 on the base 1, and the top cover 8 are configured respectively for fixing the bottom and top of the cell. Each of the fixing grooves 2 is provided with a clamping assembly disposed therein, the clamping assembly includes multiple clamping parts uniformly distributed around the cell, a clamping space for fixing the cell is formed among the clamping parts, each of the clamping parts is connected with an adjusting assembly, and the adjusting assembly can drive the corresponding clamping part to move so as to adjust the size of the clamping space and fix the cells with different sizes. Here, “different sizes” specifically refer to different radial sizes. That is, when the cell is cylindrical, the term different sizes refers to different diameters.

In the embodiment, the height of the top cover 8 can be adjusted through the lifting assemblies so as to apply to the cells with different heights. The corresponding clamping part can be driven to move through the adjusting assembly so as to adjust the size of the clamping space and apply to the cells with different sizes so that the cell module bracket can apply to the cells with different sizes and different heights, and the practicability is improved.

What needs to be explained is that the cell is usually cylindrical, and a fixing structure in the embodiment described below is applicable to the cylindrical cell.

In the embodiment, the fixing groove 2 is preferably a circular groove, and multiple fixing grooves 2 are uniformly distributed on the top cover 8 and the base 1 in an array mode, where the diameter of the fixing groove 2 is slightly large so as to preferably match different cell diameters. Further, the fixing groove 2 is a circular groove formed and enclosed by an annular plate, and a supporting plate 11 is arranged at the bottom of the fixing groove 2 of the base 1. The bottom of the cell can be supported, so that the stability is further improved.

In the embodiment, the clamping part is a clamping plate 3, and one side, adjacent to the cell, of the clamping plate 3 is provided with an arc abutting surface that is abutted with the cell. Moreover, the abutting surface of the clamping plate 3 is covered with a rubber layer, and a surface of the rubber layer is coated with an insulating rubber layer. Clamping plate 3 can prevent the cell from destroying a blue film when in contact with it, and clamping plate 3 can also be good for heat insulation capacity. The specific number of the clamping plates 3 in each clamping assembly can be selected according to working needs.

Specifically, as shown in FIG. 1 to FIG. 3, two clamping plates oppositely on both sides of the cell.

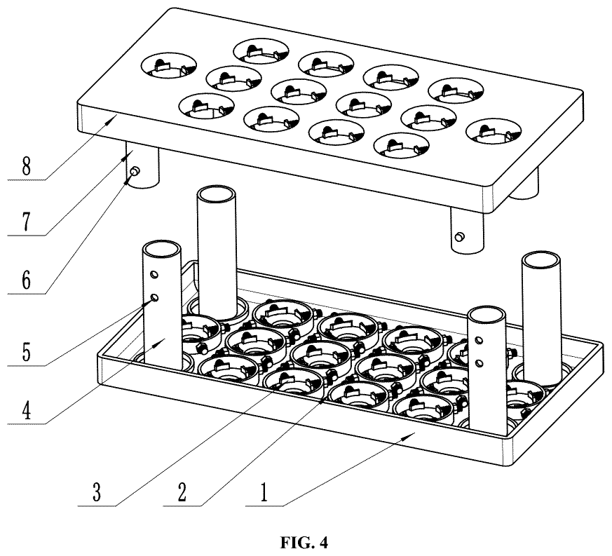

Optionally, as shown in FIG. 4 to FIG. 7, four clamping plates 3 are arranged, and the four clamping plates 3 are uniformly distributed along the circumferential direction of the cell.

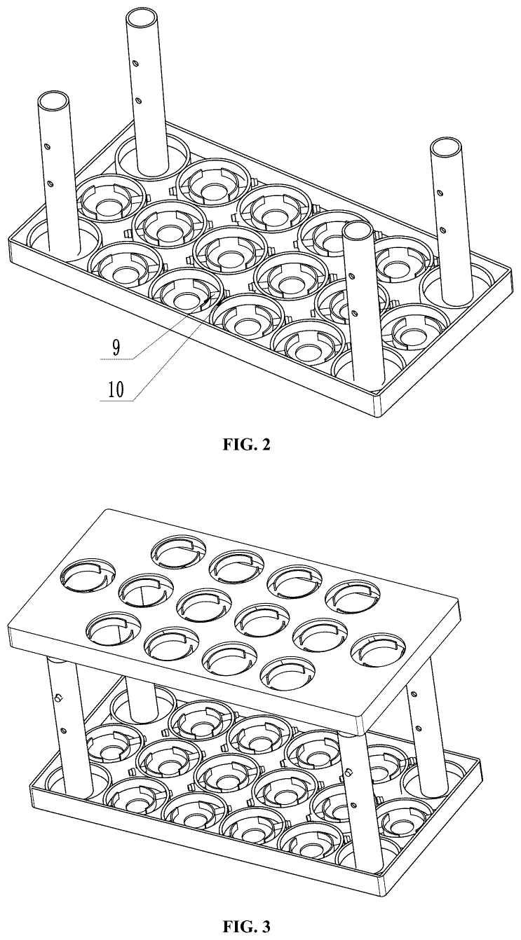

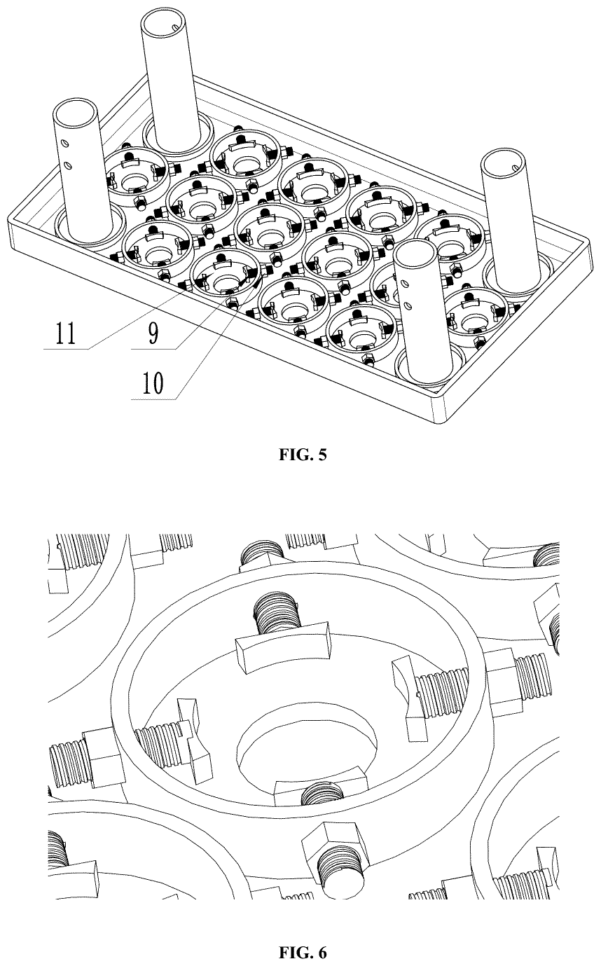

In the embodiment, as shown in FIG. 2, FIG. 5, and FIG. 6, the adjusting assembly mainly includes a bolt 9 and an adjusting nut 10. One end of bolt 9 is connected with one side, away from the cell, of the clamping part, and the other end of bolt 9 penetrates through the annular plate and is mounted with the adjusting nut 10. The clamping part can be driven to move by rotating the adjusting nut 10, so that the cell module bracket is suitable for fixing the cells with different diameters.

Further, what needs to be explained is that in the embodiment, the cell module bracket is suitable for fixing the cylindrical cells and can also be configured for fixing cells with other shapes by changing the shapes of the clamping plate 3 and the fixing groove 2. For example, the clamping plate 3 can be shaped to be a square plate, and the fixing groove 2 can be a square groove, so the cell module bracket is suitable for fixing square cells.

In the embodiment, the lifting assembly includes a lower upright post 4 and an upper upright post 7, and the lower upright post 4 and the upper upright post 7 are vertically arranged on the base 1 and the top cover 8, respectively; where the upper upright post 7 is slidably connected to the lower upright post 4, and the upper upright post 7 and the lower upright post 4 can be locked to each other through a locking mechanism.

In the embodiment, a central hole is axially formed in the lower upright post 4, and the bottom of the upper upright post 7 is slidably arranged in the central hole. The locking mechanism includes a limiting pin 6 and limiting hole 5. The limiting pin 6 is arranged in a radial direction on a side wall of the upper upright post 7. A return spring is arranged between the limiting pin 6 and the upper upright post 7. Multiple limiting holes 5 are arranged in the lower upright post 4 along an axis of the lower upright post 4. The limiting holes 5 radially penetrate through a side wall of the lower upright post 4, so that the height of the top cover 8 can be adjusted by clamping the limiting pin 6 in the limiting holes 5 at different positions. When the upper upright post 7 needs to be moved, only the limiting pin 6 needs to be pressed so as to be separated from the limiting hole 5, and then the upper upright post 7 can be moved.

In the embodiment, the base 1 and the top cover 8 are both rectangular structures, and the lifting assemblies are arranged between the four corners of the base 1 and the four corners of the top cover 8, respectively.

In the embodiment, a cell module is also provided, including the cell module bracket.

Specific examples are used for illustration of the principles and implementation methods of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

What is claimed is:

1. A cell module bracket comprising a base and a top cover, wherein the base and the top cover are connected to each other through lifting assemblies, and the lifting assemblies are configured for adjusting the height of the top cover; each of the base and the top cover is formed with a plurality of fixing grooves, and the plurality of fixing grooves of the base are in one-to-one correspondence to the plurality of fixing grooves of the top cover; wherein each of the fixing grooves is provided with a clamping assembly disposed therein, the clamping assembly comprises a plurality of clamping parts, which are configured to be uniformly distributed around a cell, a clamping space for fixing the cell is formed among the plurality of clamping parts, each of the clamping parts is connected with an adjusting assembly, and the adjusting assembly is able to drive a corresponding one of the clamping parts to move so as to adjust a size of the clamping space.

2. The cell module bracket according to claim 1, wherein the fixing grooves of the top cover are uniformly distributed in the top cover in an array mode, the fixing grooves of the base are uniformly distributed in the base in an array mode, wherein each of the fixing grooves of the top cover and the fixing grooves of the base is formed and enclosed by an annular plate, and a bottom of each of the fixing grooves of the base is provided with a supporting plate.

3. The cell module bracket according to claim 2, wherein the clamping parts are clamping plates, and one side, adjacent to the cell, of each of the clamping plates is provided with an abutting surface that is abutted with the cell.

4. The cell module bracket according to claim 3, wherein the abutting surface of each of the clamping plates is covered with a rubber layer, and a surface of the rubber layer is coated with an insulating rubber layer.

5. The cell module bracket according to claim 3, wherein the clamping plates comprise two clamping plates, and the two clamping plates are oppositely arranged on both sides of the cell;
or, the clamping plates comprise four clamping plates, and the four clamping plates are uniformly distributed along a circumferential direction of the cell.

6. The cell module bracket according to claim 2, wherein the adjusting assembly comprises a bolt and an adjusting nut, one end of the bolt is connected with one side, away from the cell, of the corresponding one of the clamping parts, an other end of the bolt penetrates through the annular plate and is mounted with the adjusting nut, and the clamping part is able to be driven to move by rotating the adjusting nut.

7. The cell module bracket according to claim 1, wherein each of the lifting assemblies comprises a lower upright post and an upper upright post, and the lower upright post and the upper upright post are vertically arranged on the base and the top cover, respectively; wherein the upper upright post is slidably connected to the lower upright post, and the upper upright post and the lower upright post are able to be locked to each other through a locking mechanism.

8. The cell module bracket, according to claim 7, wherein a central hole is axially formed in the lower upright post, and the bottom of the upper upright post is slidably arranged in the central hole; the locking mechanism comprises a limiting pin and a plurality of limiting holes, the limiting pin is arranged in a radial direction on a side wall of the upper upright post, a return spring is arranged between the limiting pin and the upper upright post, the limiting holes are arranged in the lower upright post along an axis of the lower upright post, and the limiting holes radially penetrate through a side wall of the lower upright post, so that the height of the top cover can be adjusted by snapping the limiting pin in the limiting holes at different positions.

9. The cell module bracket according to claim 7, wherein the base and the top cover are both of rectangular structures, and the lifting assemblies are arranged between four corners of the base and four corners of the top cover.

10. A cell module comprising the cell module bracket according to claim 1.

11. The cell module bracket according to claim 3, wherein the adjusting assembly comprises a bolt and an adjusting nut, one end of the bolt is connected with one side, away from the cell, of the corresponding one of the clamping parts, an other end of the bolt penetrates through the annular plate and is mounted with the adjusting nut, and the clamping part is able to be driven to move by rotating the adjusting nut.

12. The cell module bracket according to claim 4, wherein the adjusting assembly comprises a bolt and an adjusting nut, one end of the bolt is connected with one side, away from the cell, of the corresponding one of the clamping parts, an other end of the bolt penetrates through the annular plate and is mounted with the adjusting nut, and the clamping part is able to be driven to move by rotating the adjusting nut.

13. The cell module bracket according to claim 5, wherein the adjusting assembly comprises a bolt and an adjusting nut, one end of the bolt is connected with one side, away from the cell, of the corresponding one of the clamping parts, an other end of the bolt penetrates through the annular plate and is mounted with the adjusting nut, and the clamping part is able to be driven to move by rotating the adjusting nut.

14. The cell module bracket according to claim 8, wherein the base and the top cover are both of rectangular structures, and the lifting assemblies are arranged between four corners of the base and four corners of the top cover.
